(19) United States
(12) Patent Application Publication
(10) Pub. No.: US 2003/0148159 A1
(43) Pub. Date: Aug. 7, 2003

(54) Printing of catalyst on the membrane of fuel cells

(76) Inventors: Philip Cox, San Jose, CA (US); Douglas Diez, Union City, CA (US); Jonathan Servaites, San Francisco, CA (US); David L. Olmeijer, San Francisco, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/325,366

(22) Filed: Dec. 19, 2002

Related U.S. Application Data
(60) Provisional application No. 60/342,972, filed on Dec. 19, 2001.

(51) Int. Cl. H01M 4/86; H01M 4/88; H01M 8/10

(52) U.S. Cl. 429/30; 502/101; 429/40

(57) ABSTRACT

A method of applying catalytic materials on the membrane of fuel cells using gravure process is provided. In accordance with the method, a catalyst ink comprising catalyst agglomerates with controlled particle size and porosity is formed. The catalyst ink is then applied onto a membrane surface using gravure process to form a catalyst layer having a plurality of three dimensional structural units substantially vertical to the membrane surface.

### FIELD OF THE INVENTION

This invention relates generally to the field of electrochemical devices and particularly to fuel cells. More particularly, this invention relates to methods of applying catalytic materials onto a membrane to produce a membrane-electrode assembly with minimal catalyst loading for maintaining high power output from fuel cells.

### BACKGROUND OF THE INVENTION

Fuel cells have been projected as promising power sources for portable electronic devices, electric vehicles, and other applications due mainly to their non-polluting nature. Of various fuel cell systems, the polymer electrolyte membrane based fuel cell technology such as polymer electrolyte membrane fuel cells (PEMFCs) and direct methanol fuel cells (DMFCs) have attracted much interest thanks to their high power density and high energy conversion efficiency. The “heart” of a polymer electrolyte membrane based fuel cell is the so called “membrane-electrode assembly” (MEA), which comprises a thin, solid proton conducting polymer membrane having a pair of electrode layers (i.e., an anode and a cathode) with dispersed catalysts on the opposing surfaces of the membrane electrolyte.

Fuel cell performance, measured by power output per unit area of membrane, depends in part on the amount of catalyst surface area that is available to a fuel. Increasing the catalyst surface area provides a greater number of reactive sites and thus improving fuel cell performance. However, noble metals which make up the catalyst are very expensive and contribute to the majority of the high costs associated with the electrodes. For instance, in the DMFC technology using an industry standard membrane such as Nafion® product form E. I. Dupont De Nemours and Company, a catalyst coverage in the range of 8 to 15 milligrams per square centimeter of membrane area can provide power outputs from about 20 to about 50 milliwatts per square centimeter of membrane area at room temperature. The cost of this amount of catalyst for a practical fuel cell is extremely high and not competitive with alternative energy sources on a “per watt” basis. It is therefore desirable to improve or maintain acceptable fuel cell performance using minimal possible catalyst loading to reduce the cost of fuel cells.

Prior art methods for preparing electrodes include applying a uniform catalyst layer or coating onto the membrane surfaces. This is done by a variety of techniques including vapor deposition of metal layers, screen printing of catalyst/polymer blends, wire rod drawing of catalyst/polymer blends across the membrane surface, and so forth. While these prior art methods can produce a relatively uniform thickness of a catalyst layer on the membrane, they do not provide a maximal catalyst surface area for exposing to a fuel due in part to the flat structure of the catalyst layer.

### BRIEF SUMMARY OF THE INVENTION

Accordingly, it is an object of the present invention to provide a method of applying catalytic materials onto a membrane with minimal catalyst loading while still maintaining an acceptable level of power density from fuel cells.

It is another object of the present invention to provide a method of applying catalysts onto a membrane that substantially reduces the cost of the fuel cells.

It is yet another object of the present invention to provide a method of applying other materials such as a gas diffusion layer onto a membrane in a manner to enhance fuel cell performance.

It is a further object of the present invention to provide a membrane-electrode assembly comprising electrode catalyst layers having three dimensional structural units with maximal catalyst surface area at a given catalyst loading on the membrane.

It is yet a further object of the present invention to provide a membrane-electrode assembly comprising electrode catalyst layers having three dimensional structural units with minimal catalyst loading while still maintaining acceptable fuel cell performance.

These and other objects are achieved by the present method of applying catalytic materials on the membrane using gravure process. In accordance with the present method, a catalyst ink comprising catalyst agglomerates with controlled particle size and porosity is formed. The catalyst ink is then applied onto a membrane surface using gravure process to form a catalyst layer having a plurality of three dimensional structural units which are preferably substantially vertical to the membrane surface.

The catalyst ink used in the present invention comprises 10-70 percent by weight of catalyst agglomerates, 1-20 percent by weight of a solvent to plasticize surfaces of said catalyst agglomerates and membrane, and 10-89 percent by weight of a non-aqueous carrier solvent.

The three dimensional structural units are formed on the membrane surface in an aspect ratio from 1:1 to 1:8. Suitable shapes of the structural units include conic, trihedron, pyramid, and any combination thereof. In one embodiment, the structural units can be truncated at the top end of the units.

The catalyst ink is applied onto the membrane surface at a catalyst loading of between 0.1 mg/cm² and 8 mg/cm² to produce an active catalyst surface area from 0.1 to 1000 cm². The fuel cell comprising the catalyst layers prepared according to the present invention can generate a power density from 20 to 50 mW/cm² at room temperature at a catalyst loading of from 0.5 to 12 mg/cm², preferably from 0.5 to 8 mg/cm², more preferably from 0.5 to 4 mg/cm², most preferably from 0.5 to 1.5 mg/cm².

In another aspect of the present invention, there is provided a membrane-electrode assembly for fuel cells. The membrane-electrode assembly comprises

a solid electrolyte membrane having a first and a second surfaces, an anode catalyst layer formed on the first surface of the membrane, and a cathode catalyst layer formed on the second surface of the membrane. Each of the anode and cathode catalyst layers preferably comprises a plurality of three dimensional structural units which are substantially vertical to the first and second surfaces of the membrane.

### BRIEF DESCRIPTION OF THE DRAWINGS

The foregoing and other objects of the invention will be more clearly understood from the following description when read in conjunction with the accompanying drawings in which:

FIG. 1 schematically shows a membrane-electrode assembly comprising electrode catalyst layers having three dimensional structural units prepared according to the present invention.

FIG. 2 schematically shows a gravure press used for applying catalytic materials onto a polymer membrane to produce an electrode catalyst layer having three dimensional structural units.

FIGS. 3A-3C schematically show the cell designs on the surface of the gravure cylinder with various cell shapes.

FIGS. 4A-4C schematically show the cell designs on the surface of the gravure cylinder with truncated ending at the bottom of the cells.

FIG. 5 schematically shows the three dimensional structure of the electrode catalyst layer applied by using gravure process according to the present invention.

FIGS. 6A-6C schematically show the individual structural units of the catalyst layer with various shapes.

FIGS. 7A-7C schematically show the individual structural units of the catalyst layer with truncated ending on the top of the units.

### DESCRIPTION OF PREFERRED EMBODIMENTS

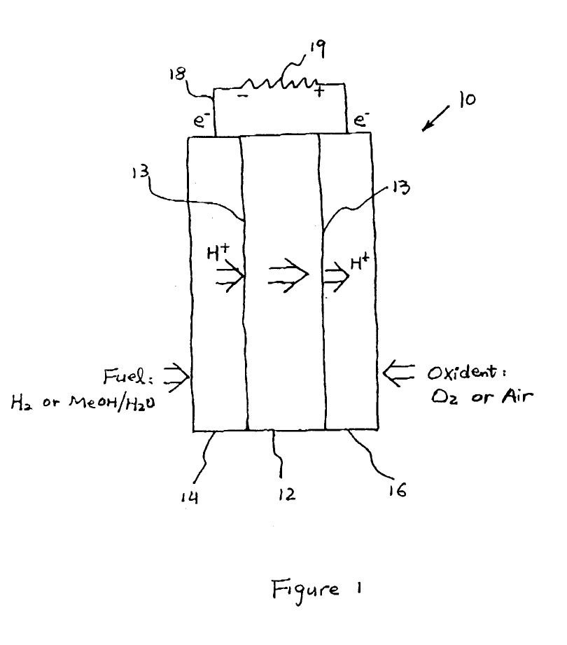

FIG. 1 schematically shows a membrane-electrode assembly (MEA) 10 comprising the electrode catalyst layers prepared according to the present invention. The MEA 10 comprises a solid proton conducting polymer membrane 12, an anode 14 and a cathode 16 which are supported on the opposing surfaces 13 of the membrane 12. Each of the anode 14 and cathode 16 comprises dispersed catalytic materials within a carrier which is in contact with each surface 13 of the membrane 12.

At the anode 14, the hydrogen or methanol molecules react with catalyst to form protons and electrons. In the case of methanol used as fuel, carbon dioxide is also formed. The electrons formed at the anode 14 travel to the cathode 16 through an external circuit 18, which produce electrical current to perform useful work by powering an electrical device 19. The protons migrate to the cathode 16 through the membrane 12. At the cathode 16, oxygen molecules catalytically dissociate and react with the protons and the electrons from the anode 14 to form water.

For a polymer electrolyte fuel cell (PEFC) using hydrogen as the fuel and oxygen as the oxidant, the reactions at the anode 14 and cathode 16 of the MEA 10 are shown in equations below:

Anode: 2H₂→4H⁺+4e⁻ (I)

Cathode: 4e⁻+4H⁺+O₂→2H₂O (II)

The hydrogen can be supplied in the form of substantially pure hydrogen or as a hydrogen-containing reformate, for example, the product of the reformation of methanol and water or the product of the reformation of natural gas or of other liquid fuels. Similarly, the oxygen can be provided as substantially pure oxygen or the oxygen can be supplied from air at ambient or elevated pressure.

For a direct methanol fuel cell (DMFC) using methanol as the fuel and oxygen as the oxidant, the reactions at the anode 14 and cathode 16 of the MEA 10 are shown in equations below:

Anode: CH₃OH 30 2H₂O→CO₂+6H⁺+6e⁻ (III)

Cathode: 6e⁻+6H⁺+3O₂→3H₂O (IV)

The methanol can be supplied in the form of a dilute methanol solution having a concentration of 1 to 50 mol % methanol in water. The oxygen can be provided as substantially pure oxygen or the oxygen be supplied from air at ambient or elevated pressure.

Polymers suitable for the membrane 12 are well known and can be any of the proton conductive polymers conventionally used in the prior art. Polymer membranes are described in U.S. patent application Ser. No. 09/872,770, the disclosure of which is hereby incorporated by reference. Other polymers suitable for the membrane include perfluorinated sulfonic acid polymers such as Nafion® from the E. I. Dupont De Nemours and Company, as well as other membranes such as Gore Select® from the Gore Company.

Suitable polymer membranes include membranes comprising a first acidic polymer, a second basic polymer, and a third elastomeric. polymer.

A used herein, the term “acidic polymer” refers to a polymeric backbone which contains one or more acidic subunits. The acidic polymer provides proton-conducting capability for electrochemical devices, especially for polymer electrolyte membrane based fuel cells such as PEMFCs and DMFCs.

Preferably, the backbone contains carbon alone, or in combination with oxygen, nitrogen or sulfur. The acidic subunits are preferably sulphonic acid, phosphoric acid and carboxylic acid groups.

Examples of acidic polymers containing sulfonic acid groups include perfluorinated sulfonated hydrocarbons, such as Nafion7; sulfonated aromatic polymers such as sulfonated polyetheretherketone (SPEEK), sulfonated polyetherethersulfone (SPEES), sulfonated polybenzobisbenzazoles, sulfonated polybenzothiazoles, sulfonated polybenzimidazoles, sulfonated polyamides, sulfonated polyetherimides, sulfonated polyphenyleneoxide, sulfonated polyphenylenesulfide, and other sulfonated aromatic polymers. The sulfonated aromatic polymers may be partially or fully fluorinated. Other sulfonated polymers include polyvinysulfonic acid, sulfonated polystyrene, copolymers of acrylonitrile and 2-acrylamido-2-methyl-1 propane sulfonic acid, acrylonitrile and vinylsulfonic acid, acrylonitrile and styrene sulfonic acid, acrylonitrile and methacryloxyethyleneoxypropane sulfonic acid, acrylonitrile and methacryloxyethyleneoxytetrafluoroethylenesulfonic acid, and so on. The polymers may be partially or fully fluorinated. Any class of sulfonated polymer include sulfonated polyphosphazenes, such as poly(sulfophenoxy)phosphazenes or poly(sulfoethoxy)phosphazene. The phosplazene polymers may be partially or fully fluorinated. Sulfonated polyphenylsiloxanes and copolymers, poly(sulfoalkoxy)phosphazenes, poly(sulfotetrafluoroethoxypropoxy) siloxane.

Examples of acidic polymers containing carboxylic acid groups include polyacrylic acid, polymethacrylic acid, any of their copolymers including copolymers with vinylimidazole or acrylonitrile, and so on. The polymers may be partially or fully fluorinated.

Examples of acidic polymers containing phosphoric acid groups include polyvinylphosphoric acid, polybenzimidazole phosphoric acid and so on. The polymers may be partially or fully fluorinated.

Preferably, the acidic polymers are sulfonated polyetheretherketone, sulfonated polyetherethersulfone, sulfonated polyetherimide, and sulfonated polyethersulfone. More preferably, the acidic polymer is sulfonated polyetheretherketon (SPEEK). The block copolymer such as SPEEK-PAMD is also preferred. It is preferred that the SPEEK be sulfonated between 50 to 200%, more preferably between 70 to 150%, and most preferably between 80 to 120%. In this regard, 100% sulfonation means every polymer repeating unit contains one sulfonic acid group.

The concentration of the acidic polymer in the membrane varies from about 10% to 99% by weight, more preferably 30 to 95% by weight, and most preferably 70 to 90% by weight.

As used herein, the term “basic polymer” refers to a polymeric backbone which contains one or more basic subunits. The basic polymer forms pseudo acid-base interaction in the membrane to stabilize the acidic polymer from dissolution in water or high humidity environment. In a preferred embodiment, the backbone of the basic polymer contains carbon alone or in combination with oxygen, nitrogen or sulfur. Particularly preferred backbones include aliphatic backbones although aromatic polymer backbones may also be used. More particularly, a basic polymer contains basic subunits which preferably comprise basic groups such as aromatic amines, aliphatic amines or heterocyclic nitrogen containing groups, oxygen containing group, and sulfur containing group.

Examples of basic polymers include aromatic polymers such as polybenzimidazole, polyvinylimidazole, N-alkyl or N-arylpolybenzimidazoles, polybenzothiazoles, polybenzoxazoles, polyquinolines, and in general polymers containing functional groups with heteroaromatic nitrogens, such as oxazoles, isooxazoles, carbazole, indoles, isoindole, 1,2,3-oxadiazole, 1,2,3-thiadiazole, 1,2,4-thiadiazole, 1,2,3-triazole, benzotriazole, 1,2,4-traozole, tetrazole, pyrrole, N-alkyl or N-aryl pyrrole, pyrrolidine, N-alkyl and N-arylpyrrolidine, pyridine, pyrrazole groups and so on. These polymers may be optionally partially or fully fluorinated.

Examples of aliphatic polyamines include polyethyleneimines, polyvinylpyridine, poly(allylamine), and so on. These basic polymers may be optionally partially or fully fluorinated.

Preferably the basic polymers are polybenzimidazole (PBI), polyvinyimidazole (PVI), and polyvinypyridine (PVP). More preferably the basic polymer are PBI and PVP. Most preferably the basic polymer is PVP.

The basic polymer can be a block copolymer with one block having basic subunits. The block copolymer can be bi-block, tri-block or multi-block copolymer. Examples of basic block copolymers include styrene-4-vinylpyridine block copolymer (styrene content 0˜80 wt %, preferably 5˜60 wt %, the most preferably 10˜40 wt %), acrylonitrile-4-vinylpyridine block copolymer, and styrene-4-vinylpyridine-acrylic acid tri-block copolymer (to improve hydration characteristics). Preferable ratio of SPEEK and polyvinylpyridine block in the block copolymer varies from 86:14 to 89:11 by weight.

The concentration of the basic polymer in the polymer blend membrane varies from 0.5% to 50%, preferably 2.5 to 40%, more preferably 5 to 25% by weight.

As used herein, an Aelastomeric polymer@ refers to a polymeric backbone which contains one or more elastomeric subunits. The function of the elastomeric polymer is to allow the fabrication of polymer membranes with superior mechanical properties as well as membranes having low methanol permeability. In a preferred embodiment, the backbone contains carbon alone or in combination with oxygen, nitrogen, fluorine or sulfur. Particularly preferred embodiments include aliphatic backbones although aromatic polymer backbones may also be used. More particularly, an elastomeric polymer comprises elastomeric subunits which preferably contain elastomeric groups such as nitrile, vinylidene fluoride, siloxane and phosphazene groups. Examples of elastomeric polymers include polyacrylonitrile, acrylonitrile copolymers, polyvinyilidene fluoride, vinylidene fluoride copolymers, polysiloxanes, siloxane copolymers and polyphosphazenes, such as poly(trifluormethylethoxy)phosphazene.

The elastomeric polymer may be added to the polymer membrane in the form of polymerizable monomer to fabricate semi-interpenetrating networks. The monomers may be polymerized photochemically or by thermal treatment for the semi-IPN.

As used herein, an elastomeric copolymer refers to an elastomeric polymer which contains elastomeric subunits and one or more acidic subunits or basic subunits depending upon which embodiment of the invention is being practiced. For example, if an acidic polymer such as sPEEK is used, an elastomeric copolymer comprising elastomeric subunits and basic subunits may be used in a binary composition. Alternatively, should a basic polymer be used, the elastomeric copolymer will comprise elastomeric subunits and acid subunits. Such binary mixtures may be used in conjunction with other polymers and copolymers to form additional compositions within the scope of the invention.

The concentration of elastomeric polymer varies from 0.5% to 50% by weight, more preferably between 2.5 to 40% by weight and most preferably between about 5 and 25% by weight.

The membrane may also contain a polymer comprising one or more functional units for improving membrane conductivity, flexibility, water remaining ability, dimension stability, and methanol crossover. As used herein, the term “functional unit” refers to functional groups contained in a polymer that can improve membrane conductivity, flexibility, hydration, water remaining ability, dimension stability over temperature, and reduce methanol crossover. The functional units include hydrophobic groups, hydrophilic groups, flexible units, and interpenetrating network (IPN) units.

Hydrophilic groups are used in the present polymer blend membrane to improve the membrane hydration rate and water retaining ability without losing significantly the dimension stability and methanol block ability. Suitable hydrophilic polymers include copolymer of vinylimdizole-vinylpyridone, and copolymer of acrylonitrile-isopropyl acrylamide. The concentration of the hydrophilic polymer in the membrane is preferably from about 0.1 to 20% by weight, more preferably 1 to 5% by weight.

Hydrophobic groups are used in the present polymer blend membrane to improve the dimension stability of the membrane. Suitable hydrophobic groups include polystyrene, polysiloxane, and polyvinyldine fluoride. The concentration of the hydrophobic groups in the membrane is preferably from about 0.1 to 50 percent by weight, more preferably from 5 to 20 percent by weight.

Flexible units are used in the present polymer blend membrane to improve the mechanical properties of the membrane and the adhesion of the membrane in the MEA. Suitable flexible units include vinylidene fluoride copolymer (Flex) and polyacrylonitrile (PAN). Preferably, vinylidene fluoride copolymer (Flex) is used. The concentration of the flexible units in the polymer blend system is preferably from about 0.1 to 50 percent by weight, more preferably from 5 to 20 percent by weight.

Interpenetrating network (IPN) functional units are preferably used in the present polymer blend membrane system to improve the membrane dimension stability. The IPN units can also provide other functions as well depending on the chemical structure of the IPN. The IPN polymers can be UV initiated and thermal initiated.

Suitable UV initiated IPN polymers include polyvinyl cinnamate. The preferred concentration of the UV initiated IPN polymer in the membrane varies from 0.5 to 30%, more preferably 1 to 5% by weight.

Suitable thermal initiated IPN polymers include silica containing polymers. Silica containing polymers have good water retaining ability. In addition, silica containing polymers can also provide good bonding mechanism in a MEA if a coupling agent is used in the catalyst ink. Examples of siloxane containing agents include tetramethyl orthosilicate (TMOS), tetraethyl orthosilicate (TEOS), and aminofunctional silicones of different molecular weight for adjusting the network size. The preferred concentration of siloxane containing agents in the present polymer blend membrane varies from 0.01% to 25% by weight, more preferably from 0.1% to 10% by weight.

Each of the anode 14 and cathode 16 comprises catalytic materials to catalyze the electrochemical reactions occurring on the electrodes. Noble metals are typically employed as the catalytic materials. Suitable noble metals include platinum, palladium, ruthenium, rhodium, osmium, iridium, and their alloys. Preferably platinum, or platinum alloys are used as catalytic material. Most preferably, the anode comprises platinum-ruthenium alloy, and the cathode comprises platinum.

The present invention employs gravure process to apply catalytic materials onto a membrane to produce a membrane-electrode assembly. Gravure process is routinely used in a variety of printing and coating applications. For instance, gravure process has been used in publication industry for printing newspapers, magazines, catalogs, and other type of commercial printing, in packaging industry for printing folding cartons and flexible packages, and other industries for printing vinyl upholsteries and polymeric films. The resulting ink layer printed by gravure process is a series of small “dots” that appear as text, pictures and graphics when viewed with unaided eyes. Gravure process is also used for applying accurately metered quantities of coating to paper, polymeric films, and other substrates. The advantages of gravure process are due to the life of the recessed images and the uniformity of ink or coating application, which result from the fact that the quantity of the ink is determined by the cell volume only, as described below.

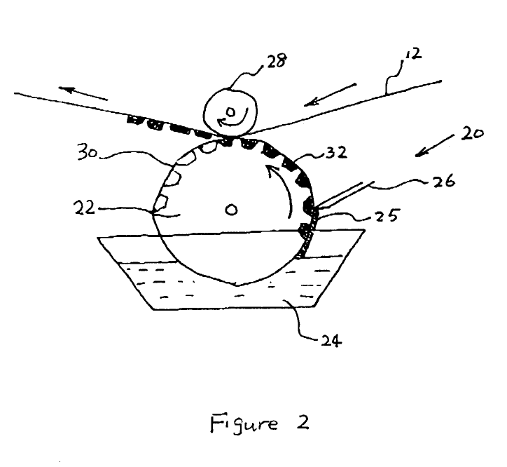

FIG. 2 schematically shows a gravure press 20 used in the present invention to lay down catalytic materials onto the membrane 12. The gravure press 20 includes a gravure cylinder 22 having a plurality of cells 32 engraved across the surface 30 of the gravure cylinder 22. The cells 32 pick up printing ink as the gravure cylinder 22 rotates through an ink fountain 24. The excess ink 25 is wiped off from the smooth surface of non-engraved portions of the gravure cylinder 22 by a doctor blade 26. The ink held in the cells is subsequently transferred to the surface 13 of the membrane 12 when the membrane 12 is pressed into contact with the ink by an impression cylinder 28.

The cells 32 on the surface 30 of the gravure cylinder 22 are designed in specific shapes to provide high quality print output. The cells 32 are typically characterized by four variables: depth, bottom, opening, and bridge. The depth of the cell 32 is measured from the bottom of the cell 32 to the surface 30 of the gravure cylinder 22. The opening is described by shape and cross sectional area. The bridge is the surface of the gravure cylinder 22 between cells 32. The doctor blade 26 rides along the cell bridges. The aspect ratio is defined by the depth and the cross section of the cell opening.

The depth, opening, bottom, and bridge of the cells 32 can be tailored to produce a range of catalyst loading and open structure. The cells can be designed having uniform opening and uniform depth. Alternatively, the cell design can be variable opening and uniform depth, or variable opening and variable depth.

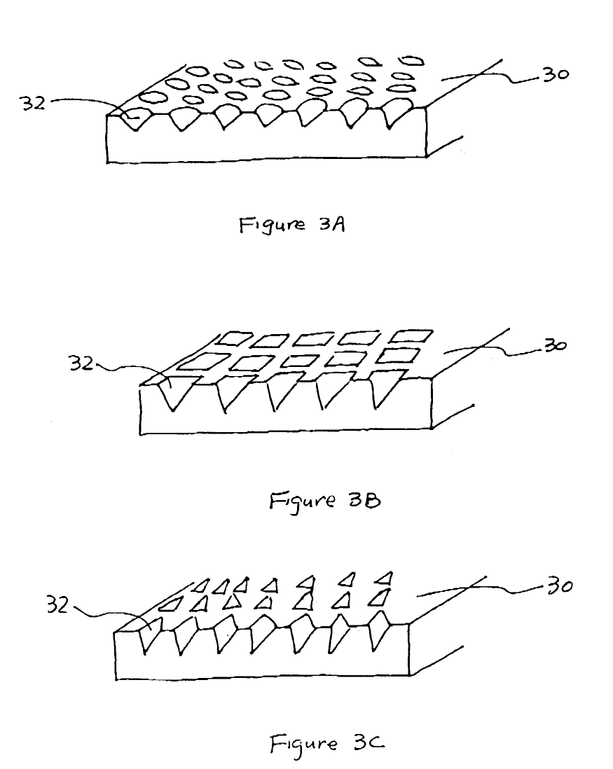

FIGS. 3A-3C schematically show the designs of the cells 32 according to one embodiment of the present invention. FIG. 3A depicts cylindrical cells; FIG. 3B depicts pyramidal cells while FIG. 3C depicts trihedral cells. The aspect ratio of each cell varies from 1:1 to 1:8 depending on printing requirements of catalysts onto the surface 13 membrane 12. Preferably the aspect ratio of the cell ranges from 1:1 to 1:4, more preferably from 1:2 to 1:4.

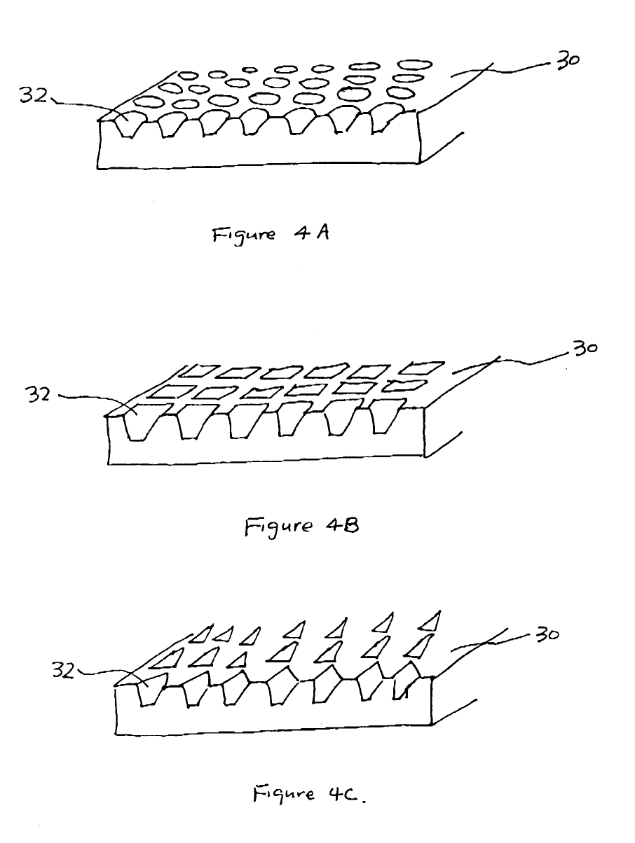

The shape of the cells 32 include conical, trihedral, pyramidal, and any combination thereof. Preferably the shape of the cells 32 is conical. In one embodiment, the cells 32 are ended in a truncated form at the bottom of the cells as illustrated in FIGS. 4A-4C.

The cells 32 can be engraved on the surface 30 of the gravure cylinder 22 using known photoengraving and electronic engraving methods. Photoengraving involves etching of lines and dots through photoresists. Conventional gravure etching employs a combination of two glass photo positives exposed to carbon tissue. Carbon tissue is a water-sensitive fibrous paper coated with a smooth gelatin resist. The process allows the tissue to be etched by ferric chloride to a depth of about 45 microns. The first glass positive is a continuous tone variable density image. The second positive is a gravure screen of specified count lines. The two positives are exposed consecutively to UV light on the same sensitized surface. After double exposure, the carbon tissue is wrapped around the gravure cylinder 22 and all backing are removed. The exposed areas are then hardened and dried. Conventional gravure etching can form cells of uniform opening with variable depth. Another photoengraving method, referred to as the direct transfer method, employs only one positive. The direct transfer method can produce cells of uniform depth with variable opening.

Electronic engraving involves the use of an electromechanical device or laser. With an electromechanical device, the gravure cylinder is engraved with a diamond stylus. The cylinder material is a laser ablated away with a high power laser. Electromechanical engraving can generate cells of different size depending on how deeply the stylus intrudes in the metal. Thus for a given stylus the depth and opening of the cells are dependent with each other. The spacing of the cells is chosen so that the diamond stylus moves between the cells of the preceding row. Laser engravers have flexibility in cell size, shape and depth. The most common laser engraved cell is circular shaped. A round dot cell gives enhanced ink release.

The catalyst ink printed onto the membrane 12 can comprise a variety of materials suitable to gravure process. In one aspect of the present invention, the catalyst ink comprises catalyst agglomerates (catalytic platinum or ruthenium agglomerates), a solvent that plasticizes the surfaces of the catalyst agglomerates and surfaces of the solid polymer membrane, and a non-aqueous carrier solvent that does not plasticize the surfaces of the catalyst agglomerates and polymer membrane. As used herein, catalyst agglomerates refer to a three dimensional structure comprising catalysts and ionomers. The proton conductive polymers that are used to prepare the catalyst agglomerates can also be included in the catalyst ink. Preferably the catalyst ink is in a non-aqueous carrier solvent having some solubility of water. U.S. patent application Ser. No. ______ describes a directly applicable catalyst composition for preparing membrane-electrode assemblies for fuel cells, the disclosure of which is incorporated herein by reference by its entirety.

Optionally, additives can be included in the catalyst ink to improve the viscosity, modify the surface tension, improve the adhesion or modify the performance characteristics of the catalysts. These additives can include carbon, electrochemically inert nonionic surfactants, or cross-linking agents such as polyvinylimmidazole polysiloxane or other adhesion promoters. In addition, additives such as silica particles, silinized or unsilinized, hydrophilic particles can also be included in the catalyst ink to improve the water management and methanol diffusion into the electrode.

The solvent that plasticize the surfaces of the catalyst agglomerates and polymer membrane can be non-aqueous or aqueous solvent, preferably non-aqueous. Suitable solvents that plasticize the surfaces of the catalyst agglomerates and polymer membrane include alcohol, water, and acetamides. Examples of such solvents include methoxyethanol, butoxyethanol, isopropylalcohol, and water.

The non-aqueous carrier solvents of the catalyst ink do not plasticize the surfaces of the polymer membrane. Preferably the non-aqueous carrier solvents have some solubility of water to provide a balance between the non-aqueous and aqueous character of the catalyst ink. Such non-aqueous carrier solvents include ketones, aliphatic or aromatic hydrocarbons, and acetate. Examples of such non-aqueous carrier solvents solvent include acetone, xylene, and n-butylacetate.

In a preferred embodiment, the catalyst ink comprises 10 to 70 percent by weight of the catalyst agglomerates, 1 to 20 percent be weight of a solvent to plasticize surfaces of the catalyst agglomerates and the surfaces of the polymer membranes, and 10 to 89 percent by weight of a non-aqueous carrier solvent.

One embodiment of the catalyst ink comprises 0.4 g of acetone, 0.94 g of catalyst Pt/Ru agglomerates, 0.4 g of Nafion solution, 0.4 g of methoxyethanol, 0.05 g carbon black (Vulcan XC-72R), and 0.8 g of xylene.

The catalyst agglomerates contained in the catalyst ink can be prepared according to the disclosure as described in U.S. patent application Ser. No. ______, which is incorporated herein by reference. In particular, particles of a catalyst are dispersed in a non-aqueous solvent to form a dispersion of the catalyst. An ion conducting polymer is added to the dispersion of the catalyst under agitation to form catalyst agglomerates. The catalyst agglomerates and the dispersion of the catalyst are stirred to control the growth of the catalyst agglomerates.

Attritors or similar ball mills can be used in the present invention to disperse the catalyst in a non-solvent, to form the catalyst agglomerates, and to control the growth of the catalyst agglomerates. Parameters of the attritor, including the bead size, the bead materials, the bead to slurry ratio, and the rotation speed and time all affect the particle size and the nature of the catalyst agglomerates. Preferably, the attritor has a bead to slurry ratio of from 30:70 to 70:30 by volume, more preferably 40:60 to 60:40, most preferably 50:50. The bead size can be in a range of from about 1 to 20 mm in diameter, preferably about 2 to 5 mm in diameter. The beads can be made of materials such as yttria stabilized zirconia, alumina, glass, and other ceramics. Preferably the beads are made of yttria stabilized zirconia. The attritor rotates at a speed of from about 50 to 500 rpm, or at an angular velocity from about 10 to 150 cm/s. The particles of the catalyst are dispersed in the non-solvent for a suitable period of time. The exact period of time can be determined according to the batch size of the attritor and the amount of catalyst to be dispersed in the non-solvent.

The non-solvent used for dispersing the catalyst in the attritor can be esters, acetates, aromatic or aliphatic hydrocarbons and ketones. Preferably the non-solvent is a hydrocarbon, ketone or an ester such as n-butyl acetate.

Preferred catalyst dispersion concentrations vary depending on the metal or alloy used. In the case of Pt/Ru catalyst, the dispersion concentration is preferably from 2 to 25 percent by weight, and more preferably from 5 to 20 percent by weight. In the case of Pt catalyst, the catalyst dispersion concentration is preferably from 2 to 25 percent by weight, and more preferably from 5 to 20 percent by weight.

In one embodiment of the present invention, sonication baths are used to disperse the catalyst particles in a non-solvent, to form the catalyst agglomerates, and to control the growth of the catalyst agglomerates.

The polymers used for forming the catalyst agglomerates are preferably proton conductive polymers. These proton conductive polymers can be the same polymers that make up the membrane electrolyte to promote reactant transport in the electrode structure, for example, to promote oxygen diffusion through the cathode or methanol diffusion in the anode. Alternatively, the proton conductive polymers can be a mixture of different ionomers to provide the best balance of properties, or can be different ionomers for each electrode or application. These proton conductive polymers must create a robust catalyst structure for catalyst retention, adhere well to the membrane-electrolyte, and enhance ion exchange capacity of the electrode. Suitable proton conductive polymers for forming catalyst agglomerates include those described in U.S. patent application Ser. No. 09/872,770, the disclosure of which is hereby incorporated by reference. Examples of suitable proton conductive polymers include those that comprise a first polymer having acidic subunits, a second polymer having basic subunits, and an elastomeric polymer having elastomeric subunits. Other proton conductive polymers include perfluorinated sulfonic acid polymers such as Nafion® from the E. I. Dupont De Nemours and Company, as well as other membranes such as Gore Select® from the Gore Company.

The amount of the polymer solution added to the dispersion of the catalyst depends on the concentration of the polymer solution. Preferred polymer solution concentrations range from about 0.5 to 5, more preferably from about 1.5 to 3, and most preferably from about 1.5 to 2.5 percent by weight. It is preferred that the amount of polymer solution added provides a weight of polymer which is preferably from 5 to 25 percent of the catalyst, more preferably from 5 to 15 for the anode and 5 to 10 for the cathode, and most preferably from 6 to 15 percent for the anode and 7.5 to 15 percent for the cathode. The best addition amount of polymers depends on the polymers, the operating conditions of targeting application such as temperature, gas humidification level, and passive or active transport of reactants to the electrode surface. The addition of the polymer into the catalyst can be performed in the level of 33 to 100% of the polymer needed to make up the final catalyst layer, more preferably in the range of 75 to 95% of the final catalyst layer.

In addition to the proton conductive polymers, other materials can be incorporated to the catalyst agglomerates to impart additional performance characteristics for the fuel cells. For instance, silaneized fumed silica or Teflon® particles can be added to improve water removal from the cathode. These particle materials can be added during the formation of the catalyst agglomerates so that they are incorporated into the structure of the catalyst, or added at the end of the formation of the catalyst agglomerates to improve the characteristics on the outside surface of the agglomerates. Materials that enhance the uptake and transport of methanol into the anode structure can also be added into the structure of the catalyst agglomerates. The addition of fumed silica into the cathode catalyst improves the performance in the presence of high water contents.

The control of the addition rate of the polymer is important to the formation of the catalyst agglomerates with controlled particle size, porosity and morphology. Since the polymer usually contains a good solvent for both the polymer and the dispersion of the catalyst, the dispersed catalyst may transfer into the aqueous phase before significant agglomeration occurs if the polymer is added too quickly. This results in a poor distribution of the polymer and a low level of catalyst agglomeration. The polymer solution is preferably added using a peristaltic or similar pump to keep a constant addition rate. For instance, the polymer solution can be added at a rate of 0.5 to 1 ml per minute for the small 1 g batch size.

Preferably the polymer solution is diluted before being added to the dispersion of the catalyst. For instance, when platinum-ruthenium black or platinum black is used as the anode catalyst and dispersed in a non-solvent such as n-butyl acetate, the polymer solution is preferably diluted in an aqueous solution. The concentration of the polymer in the dilute aqueous solution can be from about 0.5 to 5% by weight. The water in the dilute aqueous polymer solution aids in wetting the hydrophilic platinum ruthenium surfaces and assists in forming the catalyst agglomerates. When platinum black is used as cathode catalyst and dispersed in a non-aqueous solvent, the polymer solution is preferably diluted in an alcoholic solution. The alcoholic solution can be a mixture of an alcohol and water in any ratio of alcohol to water from 0.01 to 100 by weight. Preferably, the alcoholic solution contains an alcohol and water in a ratio of about 1 by weight. The preferred alcohol used to dilute the polymer solution is isopropanol.

During the addition of the diluted polymer solution to the dispersion of the catalyst, the mixture is agitated using ultrasonic or a high shear mixer at a temperature from about 0 to 100° C., preferably from 20 to 50° C. The level of dispersion in this step is carefully controlled to avoid over-dispersion of the catalyst and formation of small or no agglomerate structure. The parameters of the attritor can be varied to control the formation of the catalyst agglomerates with the desired particle size, porosity, and pore size distribution. Preferably, the attritor has a bead to slurry ratio of from 30:70 to 70:30 by volume, more preferably 40:60 to 60:40, most preferably a ratio of 50:50. The bead size can be in a range from about 1 to 20 mm in diameter, preferably in a range of 2 to 5 mm in diameter. The beads can be made of materials such as yttria stabilized zirconia, aluminia, glass, and other ceramics. Preferably the beads are made of yttria stabilized zirconia. The attritor rotates at a speed of from about 1 to 500 rpm, preferably from about 300 to 500 rpm for a 75 cc attritor bowl.

The Decane method was used to measure the porosity of the catalyst agglomerates prepared according to the present invention. The Decane method is based on the penetration of the decane non-wetting solvent in the catalyst pore structure. A pore volume is calculated by converting the amount of decane that penetrates the structure. The Decane analysis showed that the catalyst agglomerates obtained by using various bead to slurry ratios have a porosity ranging from 25 to 70 percent by volume.

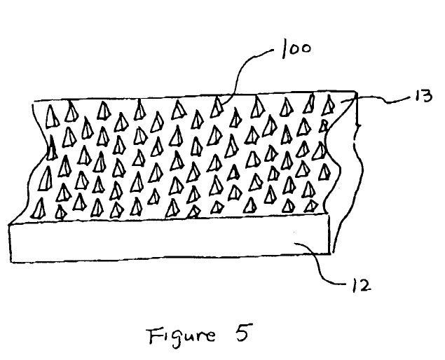

The structure of the catalyst layer applied onto the membrane 12 by gravure process reproduces the structure of the cells 32 on the gravure cylinder 22. As schematically shown in FIG. 5, one of the distinguishing features of the catalyst layer prepared according to the present invention is that it is consisted of a plurality of three dimensional structural units 100, rather than a flat uniform thickness as in prior art. These three dimensional structural units 100 are substantially vertical above the membrane 12, providing maximal catalyst surface area for exposing to fuels or oxidants.

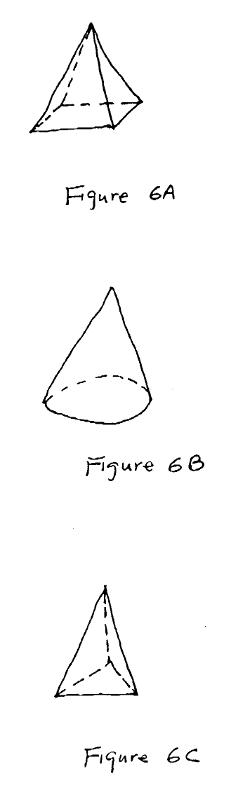

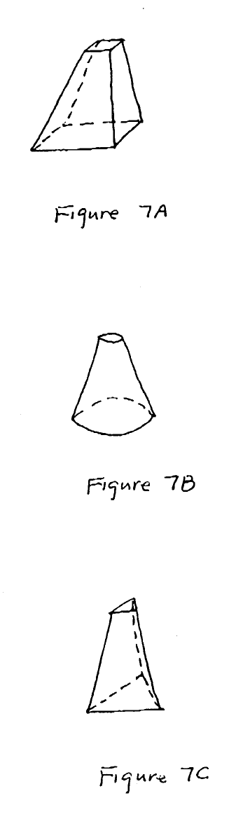

FIGS. 6A-6C schematically show the individual three dimensional structural units 100 of the catalyst layer applied using gravure process according to the present invention. As shown in FIGS. 6A-6C, the individual structural units 100 can be conical, pyramidal, trihedral. FIGS. 7A-7C show that the structural units 100 can be truncated at the top, corresponding to the truncated bottom of the cells 32 as illustrated in FIGS. 4A-4C.

The structural units 100 of the catalyst layer prepared according to the present invention have an aspect ratio ranging from 1:1 to 1:8, preferably from 1:1 to 1:4, more preferably from 1:2 to 1:4. These three dimensional structural units 100 provide an active catalyst surface area of catalyst from 0.1 to 1000 cm² at a catalyst loading of 0.1 to 8 mg/cm². This improvement of active catalyst surface area can be better represented by the increase of power density as measure by miliwatts per square centimeter of membrane area (mW/cm²). In prior art, a power density ranging from 20 to 50 mW/cm² requires a catalyst loading in a range from 8 to 15 mg/cm² of membrane area. In accordance with the present invention, a significant lower amount of catalyst loading is needed to produce the same range of power density. The fuel cell comprising the catalyst layers prepared according to the present invention can generate a power density from 20 to 50 mW/cm² at room temperature at a catalyst loading of from 0.5 to 12 mg/cm², preferably from 0.5 to 8 mg/cm², more preferably from 0.5 to 4 mg/cm², most preferably from 0.5 to 1.5 mg/cm².

The electrode catalyst layers having three dimensional structural units according to the present invention provide many advantages over the prior art electrode catalyst structure which is typically flat and uniform. Three dimensional structural units provide greater active catalyst surface area than flat structure at a given catalyst loading on the membrane, thus enhancing fuel cell performance. Furthermore, to maintain acceptable fuel cell performance, minimal catalyst amounts in the present invention are needed thanks to the increasing of the active surface area available for exposing to fuels or oxidents, thus reducing the cost of fuel cells. According to the present invention, a reduction in the range of 25% to 50% of catalyst amount used in the prior art fuel cells can be achieved while still maintaining substantially the same power density. In some embodiments, 50% to 80% reduction can be achieved. In a preferred embodiment, 80% to 90% reduction can be achieved while still maintaining acceptable power density from the fuel cells.

The foregoing description of specific embodiments and examples of the invention have been presented for the purpose of illustration and description, they are not intended to be exhaustive or to limit the invention to the precise forms disclosed. Obviously many modifications, embodiments, and variations are possible in light of the above teaching. It is intended that the scope of the invention encompass the generic area as herein disclosed, and by the claims appended hereto and their equivalents.

What is claimed is:

1. A method of preparing an electrode for an electrical device, comprising:
forming a catalyst ink comprising catalyst agglomerates with controlled particle size and porosity;
applying said catalyst ink onto a surface of a membrane to form a catalytic layer comprising a plurality of three dimensional structural units comprising said catalyst agglomerates.

2. The method of claim 1 wherein said catalyst ink is applied onto said surface of said membrane at a catalyst loading of 0.1 to 8 mg/cm² to produce an active catalyst surface area of from 0.1 to 1000 cm².

3. The method of claim 1 wherein said three dimensional structural units are formed on said surface of said membrane in an aspect ratio from 1:1 to 1:8.

4. The method of claim 1 wherein said three dimensional structural units are formed on said surface of said membrane in a shape including conical, trihedron, pyramidal, and any combination thereof.

5. The method of claim 1 wherein said catalyst ink is applied onto said surface of said membrane using gravure printing process.

6. The method of claim 1 wherein said catalyst ink is applied onto said surface of said membrane at a catalyst loading from 0.5 to 12 mg/cm² to generate a power density of from 20 to 50 mW/cm at room temperature.

7. The method of claim 6 wherein said catalyst ink is applied onto said surface of said membrane at a catalyst loading from 0.5 to 1.5 mg/cm² to generate a power density of from 20 to 50 mW/cm² at room temperature.

8. The method of claim 1 wherein said catalyst ink is formed by mixing 10-70 percent by weight of catalyst agglomerates, 1-20 percent by weight of a solvent to plasticize surfaces of said catalyst agglomerates and membrane, and 10-89 percent by weight of a non-aqueous carrier solvent.

9. A membrane electrode assembly for an electrical device, comprising:
a solid electrolyte membrane having a first and a second surfaces;
an anode catalyst layer formed on said first surface of said membrane; and
a cathode catalyst layer formed on said second surface of said membrane;
wherein each of said anode and cathode catalyst layers comprises a plurality of three dimensional structural units vertical to said first and second surfaces of said membrane.

10. The membrane electrode assembly of claim 9 wherein said three dimensional structural units have an aspect ratio from 1:1 to 1:8.

11. The membrane electrode assembly of claim 9 wherein said three dimensional structures comprise a shape including conical, trihedron, pyramidal, and any combination thereof.

12. The membrane electrode assembly of claim 9 wherein said three dimensional structural units comprise an active catalyst surface area from 0.1 to 1000 cm² at a catalyst loading of 01. to 8 mg/cm²

13. The membrane electrode assembly of claim 9 wherein said three dimensional structural units generate a power density of from 20 to 50 mW/cm² at room temperature at a catalyst loading of from 0.5 to 12 mg/cm².

14. The membrane electrode assembly of claim 13 wherein said three dimensional structural units generate a power density of from 20 to 50 mW/cm² at room temperature at a catalyst loading of from 0.5 to 1.5 mg/cm².
